(19) United States
(12) Patent Application Publication
(10) Pub. No.: US 2009/0125346 A1
(43) Pub. Date: May 14, 2009

(54) PERFORMANCE RECONCILIATION TOOLS

(76) Inventor: William Joseph LOCONZOLO, Wayland, MA (US)

Correspondence Address: Pearl Cohen Zedek Latzer, LLP, 1500 Broadway, 12th Floor, New York, NY, 10036, US

(21) Appl. No.: 11/939,368

(22) Filed: Nov. 13, 2007

(51) Int. Cl. G06Q 10/00

(52) U.S. Cl. 705/7

(57) ABSTRACT

Apparatus, a method, or one or more subparts thereof may be provided. A reconciliation process invoker may be provided which is configured to cause a given state change intended to invoke a given reconciliation process. Media-stored reconciliation processes may be provided, including the given reconciliation process, executable by a reconciliation process execution mechanism. The media-stored given reconciliation process may include instructions configured to instruct a change, upon execution of the given reconciliation process by the reconciliation process execution mechanism, of one or more configuration parameters of at least one performance factor system. A set of reconciliation process fields may be provided, which may be provided as part of a computer screen display user interface. The reconciliation process fields may include, in part, state identifier fields configured to hold reconciliation process state identifiers, sub-process fields, associated with respective states identified by ones of the process state identifiers, configured to hold sub-process identifiers identifying sub-processes to be executed during execution of the reconciliation process, and corresponding sub-process parameters for the identified sub-processors. Business process definition fields may be provided, which may be presented as part of a computer screen displayed user interface. The business process definition fields may include at least one identifier field configured to hold an identifier parameter to identify the business process being defined, a vertical segment field to hold a vertical segment identifier field, a function field to hold a function identifier, and a version field to hold version data. A reconciliation process status interface may be provided which includes reconciliation process status information interface tools. A reconciliation process invocation control interface may be provided, which includes reconciliation invocation control tools.

### COPYRIGHT NOTICE

This patent document may contain information subject to copyright protection. The copyright owner has no objection to the facsimile reproduction by anyone of the patent document or the patent, as it appears in the US Patent and Trademark Office files or records, but otherwise reserves all copyright rights whatsoever.

### FIELD OF THE DISCLOSURE

Aspects of the present disclosure relate to performance management systems and subsystems.

### BACKGROUND

“Performance measurement systems” include computer-based platforms and applications that gather data, and analyze that data to produce performance metrics (for example, metrics from or similar to the Saratoga Institute measures). “Performance management systems” produce performance metrics, and they provide the metrics to people responsible for a given performance metric. For example, some performance management systems show employees their own performance metrics data. When this is done, there is a significant increase in the performance level of the individual employees and of the enterprise as a whole.

Fitz-Enz et al. explain, in their book entitled “How to Measure Human Resources Management” (3^{rd} Ed., 2002; McGraw-Hill (pages 286-287)), some of the challenges encountered when employing technology for performance management. Specifically, they state the following:

“Along with the proliferation of technology has come a growing concern about misdirection. A number of technology experts have pointed out that technology is a tool, not a destination. Their concern is that HR management might focus too much on internal technology applications. Greater opportunities lie in expanding the effects of HR's technology-enhanced services toward the business of the enterprise. Staff managers are susceptible to putting their heads down and working on their processes. They need to improve their ability to think beyond the day's work and the steps in their processes. The point of this and of all work is to serve the goal of the enterprise. This result, not the process, must be the focal point if HR is to transform itself from an expense center to a business partner.”

They further point out that vendors are developing products that move HR from back-office administration toward problem analysis and resolution and forecasting. Included in these systems are both quantitative benchmarks and employee survey data. By following decision trees using both hard and soft data, HR departments will be able to find quick solutions to present problems and begin to forecast the likelihood of various human capital occurrences.”

In the area of performance management systems, one goal is to “expand the effects of technology-enhanced services toward the business of the enterprise,” as suggested by Fitz-Enz et al. It is important to point out that making substantial strides to achieve this objective is easier said than done.

### SUMMARY OF THE DISCLOSURE

In accordance with certain embodiments of the present disclosure, one or more objectives may be achieved, including, for example, aiding the reconciliation of performance management data, including performance metrics, to better align various performance factor resources that contribute to the desired performance of individuals, of departments, of groups, and of the enterprises as a whole. In accordance with some aspects of this disclosure, certain information regarding performance metrics is evaluated, and configuration parameters of performance factor resources are adjusted. Such performance factor resources include systems and processes that contribute to or affect performance metrics.

In accordance with one embodiment, apparatus, a method, or any subpart of such apparatus or method may be provided to facilitate reconciliation of a performance management system. In addition to, or rather than, apparatus or a method, the invention, in accordance with certain embodiments, may be directed to machine-readable (or computer-readable) media holding data that, when interacting with a machine or a computer, causes the various apparatus elements to be formed, or causes the method (or any part of the method) to be carried out.

In accordance with one embodiment, apparatus are provided, including a reconciliation process invoker, and media-stored reconciliation processes. The reconciliation process invoker is configured to cause a given state change intended to invoke a given reconciliation process. The media-stored reconciliation processes include the given reconciliation process, and are executable by a reconciliation process execution mechanism. The media-stored given reconciliation process includes instructions configured to instruct a change, upon execution of the given reconciliation process by the reconciliation process execution mechanism, of one or more configuration parameters of at least one performance factor system.

In accordance with another embodiment, apparatus are provided, including reconciliation process fields, a reconciliation process association mechanism, and a set of media-stored sub-processes. The reconciliation process fields include, in part, state identifier fields configured to hold reconciliation process state identifiers, sub-process fields, associated with respective states identified by ones of the process state identifiers, configured to hold sub-process identifiers identifying sub-processes to be executed during execution of the reconciliation process. The sub-process fields are further configured to hold corresponding sub-process parameters for the identified sub-processes.

The reconciliation process association mechanism may be configured to associate given parameters, upon such given parameters being held by the reconciliation process fields, with a media-stored corresponding reconciliation process defined, at least in part, by the given parameter. The reconciliation process may include an instruction that, when executed, is configured to cause a change of one or more configuration parameters. The set of media-stored sub-processes include configuration parameter change sub-processes, each of which, when executed, instructs a change of one or more configuration parameters of at least one performance factor system.

In accordance with another embodiment, apparatus are provided, which include business process definition fields and an association mechanism. The business process definition fields include at least one identifier field configured to hold an identifier parameter to identify the business process being defined. The business process definition fields further include a vertical segment field to hold a vertical segment identifier field. In addition, a function field may be provided to hold a function identifier, and a version field may be provided to hold version data describing the version of the current business process definition. The association mechanism may be configured to associate given parameters, upon being held by the business process definition fields, with a media-stored corresponding business process defined at least in part by the given parameters.

In accordance with another embodiment, apparatus are provided, including a reconciliation process status interface. The reconciliation process status interface includes reconciliation process status information interface tools. The reconciliation status information interface tools may be configured to present, to a user, via one or more computer screen displayed graphical representations, data conveying reconciliation processes, certain status information regarding the reconciliation processes, and other information about the reconciliation processes.

In accordance with another embodiment of the present disclosure, apparatus may be provided including a reconciliation process invocation control interface. The reconciliation process invocation control interface includes reconciliation process invocation control tools. These tools are configured to present to a user, via one or more computer screen graphical representations, controls to effect how and when an invocation causing state change is made to occur by a reconciliation process invoker. The invocation causing state change is intended to cause an invocation of a reconciliation process resulting in a change of one or more configuration parameters of at least once performance factor system.

### BRIEF DESCRIPTION OF THE DRAWINGS

Embodiments of the disclosure are further described in the detailed description which follows, by reference to the noted drawings, in which like reference numerals represents similar parts throughout the several views of the drawings, and wherein:

FIG. 1 is a block diagram illustrating a performance IT system;

FIG. 2 is a block diagram illustrating, schematically, performance factor resources and performance factors thereof;

FIG. 3 is a diagram that schematically illustrates an example of a reconciliation process definition data structure or interface;

FIG. 4 is a schematic diagram of a business process definition data structure or interface;

FIG. 5 is a schematic diagram of a reconciliation process status data structure or interface; and

FIG. 6 is schematic diagram of a reconciliation process control data structure or interface.

### DETAILED DESCRIPTION

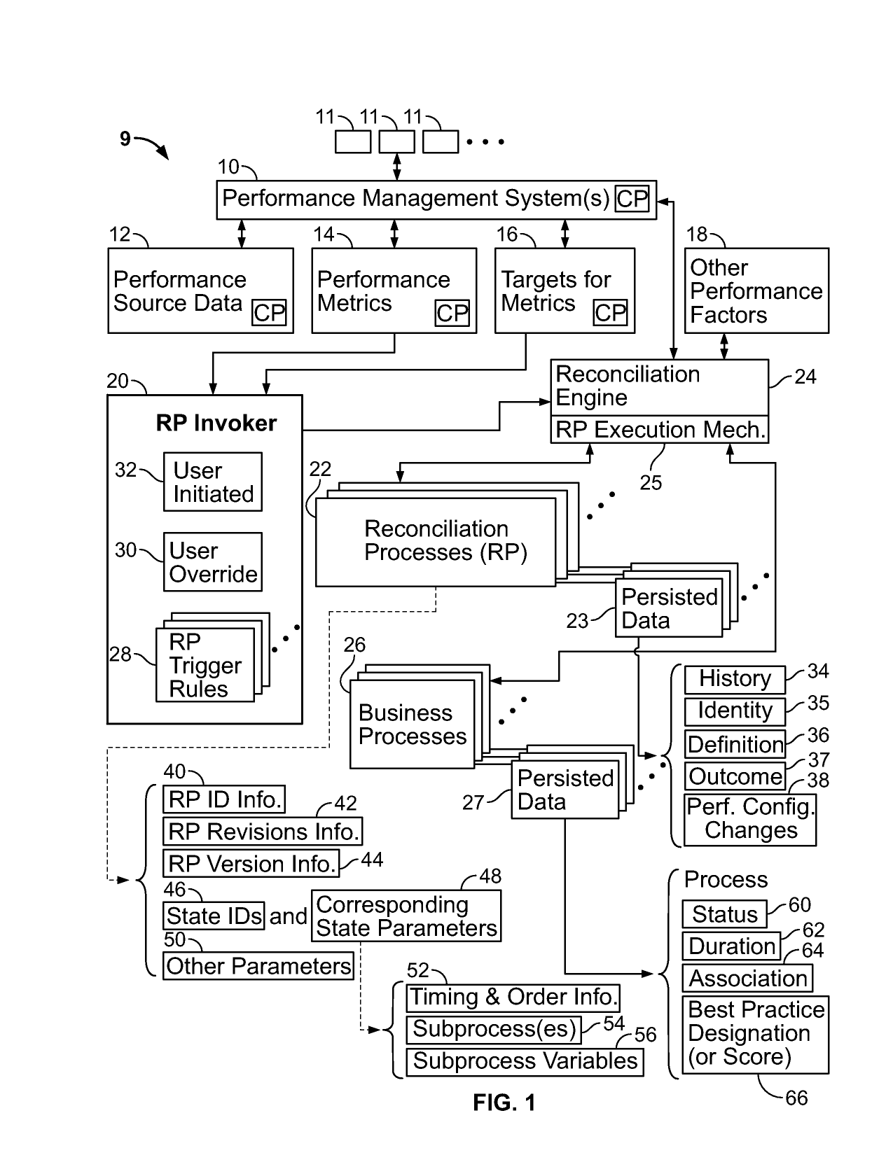

Referring now to the drawings in greater detail, FIG. 1 is a block diagram of a performance IT (Information Technology) system 9. The illustrated system 9 includes one or more performance management systems 10, coupled to (and/or comprising) a number of access units 11. Access units 11 may be displays, outputs, and/or computer devices (e.g., laptops, desktops, or other types of computing devices, including smaller devices, communications devices, etc.). Media-stored performance source data 12, performance metrics 14, and targets for metrics 16 are provided, each of which is coupled to performance management system(s) 10.

The illustrated performance source data 12, performance metrics 14, and targets for metrics 16 may be provided in one or more databases across one or more platforms or systems. Performance source data 12 generally includes, for example, raw data that is performance-related. This data may be obtained (to name just a few examples) from a call center switch, a security token system (which may access and log information concerning the location of employees in a particular building or when they access a particular network or machine), computer login information concerning departments or individual personnel, and manually input information. Performance metrics 14 includes objective performance data that is quantitative, and that is determined based on a calculation or analysis of the performance source data 12. Performance metrics may be associated with a particular business unit, a particular department, or an individual personnel member (for example, an employee).

Targets for metrics 16 are targets that may be set by management (or that may be set dynamically by a reconciliation process), and the achievement of a given target may indicate a desired level of performance or an undesirable phenomenon concerning performance. “Schedule adherence” may be one type of performance metric that is important in a given context, for example, a call center. A given schedule adherence performance metric may indicate that a given employee, over a given period of time, for example, during the month of September 2005, was present during his or her scheduled hours a given percentage of the total scheduled hours. The performance metric may be a numerical value representing a percentage, and may include data associating it with a period of time for which this percentage value is applied as well as associating it with the particular individual being measured. The corresponding performance source data allowing calculation of the schedule adherence performance metric may include, for example, the schedule approved by the employee's supervisor, which may be input via a human resource scheduling computer system.

Additional performance source data may include actual working hours based on times that the employee is present at his workstation, which may be represented by the use of time sheets (either physical time sheets with subsequent data entry) or time sheets populated by a computer screen input into human resources software. Actual work hours can also be extracted via log-on, breaks, and log-off times from telephony, CRM, and workflow management systems. This can be an accurate determination of what the employee has done, and in the case described (schedule data), can provide accurate schedule conformance and adherence metrics. This actual working hours number may be confirmed, supplemented, or otherwise based upon other data concerning the presence of the employee during scheduled working hours, for example, including times that the employee is logged onto his or her workstation computer, and/or times that the employee is in the building, information which can be based upon the employee's use of a security token allowing him or her access to the building and/or allowing him or her access to an assigned workstation computer.

A “target” for the schedule adherence, stored in targets for metrics 16, may be determined as an objective, for a given period of time (for example, a certain quarter) that employees of a certain category are present at their workstations a given percent of the time, and for a given experience level. The given experience level may be an experience level an employee may have during the given period of time, which may be based on tenure, experience, and/or training. If this objective is reached or exceeded (for example, either by a defined threshold, or by a percentage difference compared to peers of the employee), that would be considered by management as a good indicator of performance.

Other examples of performance metrics for a call center might include: average time per call (usually called an average handle time (AHT)); number of calls handled per shift; agent active time (which may be recorded by a telephone surveillance system that records every time an agent signs on or is off line); holding time; abandonment rate (this is, when a caller tires of waiting and terminates the call before an agent answers the call); staff loading costs; and queue size.

Aggregation-based performance metrics may also be included in the performance metrics. For example, manager performance may be an established metric that is calculated based upon an aggregation of the measures listed above for a given call center. This data may be presented by performance management system or systems 10 in different ways. For example, dashboards, balanced score cards, tables, and/or charts may be used.

A given performance metric may be provided with certain targets to determine whether the given performance metric is to be categorized in the satisfactory, marginal, or problem category. The certain targets may all be proportional to a multiple ranged rating definition.

Each of performance source data 12, performance metrics 14, and targets for metrics 16 includes a set of configuration parameters (CP). For example, performance source data configuration parameters (CP) may be established, added to, or modified to change the type of raw data (performance source data) that will be gathered as performance source data. Configuration parameters of the performance source data 12 may also be set, modified, or added, to establish different associations of certain raw data with various types of performance source data. Performance metrics subsystem 14 may also include configuration parameters (CP) for configuring the type of performance metrics that will be calculated, the mathematical or other operations to be performed on the performance source data to determine each performance metric, and association information, for example, whether a given performance metric is to be associated with a particular person, group, or manager. Targets for metrics 16 include configuration parameters (CP), for defining the types of targets for metrics, and for associating those targets with particular performance metrics 14.

Performance management system or systems 10 may also include configuration parameters (CP), to configure, for example: the types of reports that are generated; the types of information (source data, metrics, and targets) to be provided for different personnel types, for example, employees, managers, outsourced personnel, and so on; the frequency with which certain reports will be provided; the frequency with which certain data and metrics will be calculated; and so on. Each of the configuration parameters which are part of performance management system or systems 10, performance source data 12, performance metrics 14, and targets for metrics 16, relates to, i.e., contributes to or affects, the performance of an individual, group, or the enterprise, and also therefore affects the performance metrics.

Accordingly, each of the configuration parameters noted may be considered performance factors. Each of the resources for which configuration parameters are provided may be considered performance factor resources.

Other performance factors 18 may also exists, which are not part of performance management system or systems 10, or any of the types of data sources 12, 14, and 16.

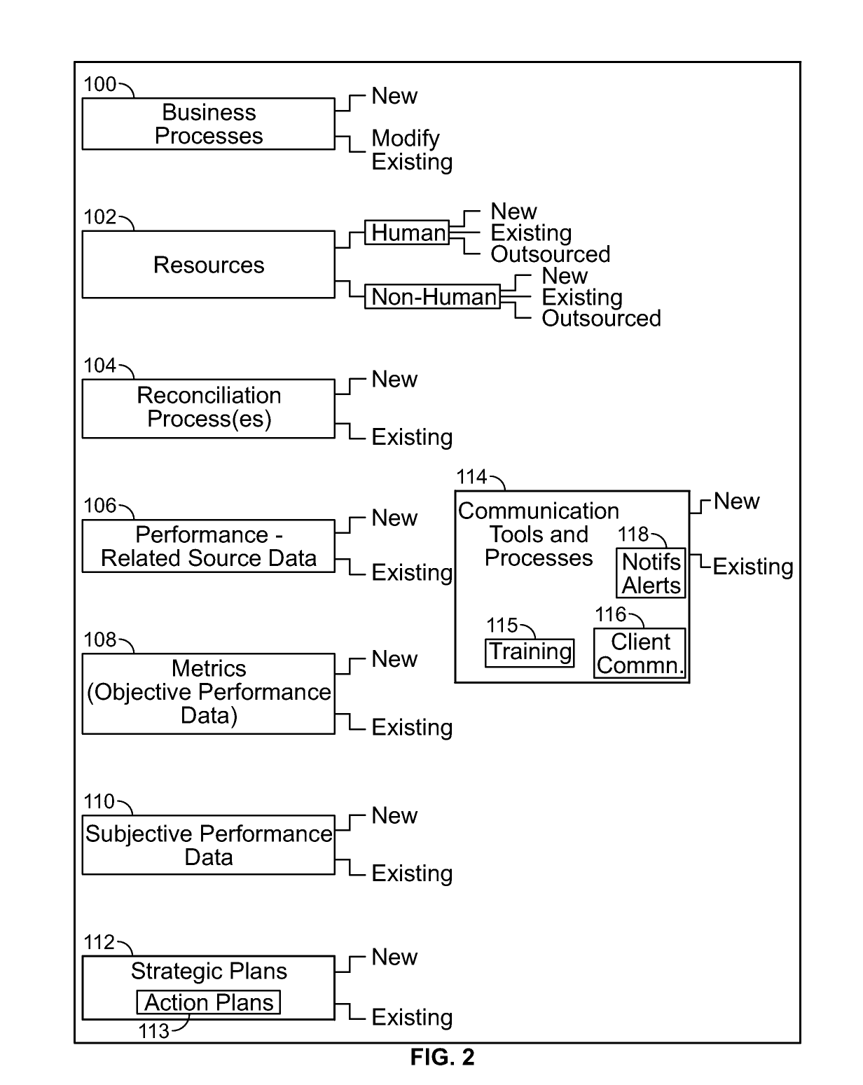

FIG. 2 is a schematic diagram of various performance factor resources and performance factors thereof. A given enterprise may include a number of performance factor resources (which may be either systems or processes), including business processes 100, resources 102, reconciliation process or processes 104, performance-related source data 106, metrics 108, subjective performance data 110, strategic plans 112 and action plans 113, and communication tools and processes 114. Each of the illustrated performance factor resources may be in the form of a computer system or subsystem. In the illustrated embodiment, each of the illustrated performance factor resources 100-114 is represented either by a particular data structure, including certain data defining the processes to be carried out, and/or a computer system for facilitating the associated process. For example, business processes 100 may include files and scripts defining certain business processes to be carried out, and a computer system that allows modification of those scripts and processes represented in certain files, and the display of those processes to users. Business processes subsystem 100 may include a work flow system. Resources 102 may include a system for managing human resources and non-human resources. In the case of non-human resources, the resources may include various hardware and computer software systems. In the case of human resources, certain human resources IT systems may be provided for identifying and keeping track of the various human resources of the organization. Accordingly, while the human resources themselves are not a system or apparatus, the system that allows for scheduling, keeping track of, and managing human resources may be embodied in an automated machine.

Reconciliation process or processes 104, in the present disclosure, include a number of processes being carried out by a computer system, either on a single platform or a distributed platform. Performance-related source data 106 may be the data that corresponds to performance source data 12 as shown in FIG. 1. Metrics 108 includes objective performance data, i.e., performance metrics, for example, performance metrics 14 as shown in FIG. 1.

Subjective performance data 110 may include additional data that is subjective, and that is provided by input, for example, from employees and managers. Subjective performance data 110 may be kept in an IT system regarding human resources. Strategic plans 112 may include action plans 113, and may be represented in an IT system, by, for example, scripts set forth in certain files, which may be represented with text or graphical tools.

Communications tools and processes 114 may include, for example, certain types of training systems, for example, a KX (knowledge exchange) system, which is a hi-tech mentoring system. Generally, communications tools and processes include training subsystems 115, client communication subsystems 116, and a notification and alert subsystem 118.

A given organization may modify the performance of certain individuals, certain groups, departments, or the entire enterprise by modifying the configuration parameters of any one or more of the subsystems 100-114 shown in FIG. 2. For example, new business processes 100 may be provided, or existing business processes may be modified. Changes can be made with respect to human resources and non-human resources. New resources can be provided, or adjustments can be made with respect to the existing resources. In addition, the certain resources can be outsourced. Similarly, new reconciliation processes 104, performance-related source data 106, metrics 108, subjective performance data 110, strategic plans 112, and communications tools and processes 114 may be provided in order to affect performance. In addition, changes to existing reconciliation processes 104, performance-related source data 106, metrics 108, subjective performance data 110, strategic plans 112, and/or communications tools and processes 114 may be provided.

The illustrated IT system 9 illustrated in FIG. 1 includes a reconciliation process invoker 20, one or more reconciliation processes 22, a reconciliation engine 24, and a set of business processes 26. Reconciliation process invoker 20 is configured to cause a given state change intended to invoke a given reconciliation process, from among the set of reconciliation processes 22.

The media-stored reconciliation processes are each executable by a reconciliation process execution mechanism 25, provided, in the illustrated embodiment, as part of reconciliation engine 24. The reconciliation process execution mechanism 25 may be a parser. In one specific embodiment, the parser may include an XML parser, while the reconciliation processes 22 include XML files.

The reconciliation process execution mechanism 25 is configured to execute the given reconciliation process invoked by the reconciliation process invoker 20 when the given state change has been caused by reconciliation process invoker 20. This may occur immediately in direct response to the given state change, or at a later time, for example, a certain delay time or at a time at which the reconciliation process arises at a certain point in a queue (not shown), which may be provided. In the illustrated embodiment, the execution mechanism includes software, which is executed when installed and executed by, for example, a general purpose processor.

Each of the reconciliation processes 22 may include instructions configured to instruct a change, upon execution of the given reconciliation process by the reconciliation process execution mechanism, of one or more configuration parameters of at least one performance factor system. The performance factor system may include one or a plurality of performance management systems 10. The one or more configuration parameters that is/are changed may include a given metric target in targets for metrics 16. The change that is caused or instructed by the given reconciliation process may be an automated change. In this case, reconciliation engine 24 automatically causes the change of the corresponding configuration parameter or parameters, which may be part of performance management system or systems 10, performance source data subsystem 12, performance metrics subsystem 14, targets for metrics subsystems 16, or other performance factors subsystems 18. The configuration parameter change may be for a given category of personnel, e.g., all occurrences of a particular performance metric for a complete category of personnel, for an entire call center. The given change may be to change one configuration parameter, or to change a plurality of different configuration parameters.

In the illustrated embodiment, reconciliation process invoker 20 includes a plural set of reconciliation process trigger rules 28, each of which can be configured to cause invoking of an associated one of the reconciliation processes 22. A given one of the reconciliation process trigger rules 28 may be configured to cause invoking of the given reconciliation process 22.

Reconciliation process invoker 20 may also be provided with a user override mechanism 30 and a user initiated mechanism 32. User override mechanism 30 may be configured to allow a user to interface via a computer screen interface to override a given reconciliation process trigger rule to either stop a particular reconciliation process or to trigger a reconciliation process notwithstanding whether the rule has been satisfied. User initiated mechanism 32 may allow a user to interact with the reconciliation process invoker 20, via a user interface, to initiate a particular reconciliation process.

Each reconciliation process 22 may be provided with persisted data 23. Persisted data 23 may include history information 35, identity information identifying the particular reconciliation process persisted, definition information 36, outcome information 37, and any performance configuration changes 38.

Persisted data 23 may be logged and persisted by an auditing function, which persists the outcome of each process that has been invoked (shown as outcome information 37 in FIG. 1). Such an audit function may allow a business owner or analyst to obtain a historical view as to which reconciliation processes that were instantiated resulted in a favorable resolution and which reconciliation processes did not result in a favorable resolution.

Each reconciliation process 22 is defined by a number of parameters, for example, calls, statements, and other elements. Such parameters may include, as shown in FIG. 1, a reconciliation process identifier 40, reconciliation process revisions information 42, reconciliation process version information 44, state identifiers 46 and corresponding state parameters 48, and other parameters 50. The illustrated corresponding state parameters 48 may include, for example, timing and order information 52 (which dictates the timing and order in which the reconciliation process will perform the actions of particular states) sub-process 54 to be performed at each particular state, and a sub-process variables 56 required for the sub-processes.

The illustrated performance IT system 9 further includes a set of business processes 26, each of which may have a corresponding set of persisted data 27. The persisted data for a given business process 26 may include process status information 60, process duration information 62, process association information 54, and whether or not the process is designated as a best practice, by way of a best practice designation 66 (or a best practice score, which, for example, may be a numerical value giving the process a rating, with higher numbers meaning that the process has a higher rating and is therefore a better practice). Each of the business processes 26 may include an open extensible file defining the process for different types of compliant platforms to run that process, for example, Microsoft, Oracle, IBM, RedHat or an open engine specifically designed for a set of business processes using a language that is custom designed. Such a language may be called a business process execution language, which utilizes XML features. The business process execution language may include XML documents, structured using streams and events, using trees and objects, or using pull parsing.

An approach may be employed to define all of the determining relationships and reasons within XML vocabularies. Specifically a WS-BPEL (Web Services-Business Process Execution Language) may be employed which is specifically leveraged to define key processes. These key processes may include definitions of what to measure, when to initiate and trigger events, and what systems to trigger, either internal or external. These processes may be defined in such a way as to promote reuse, publication and extensibility. Modularization via WS-BPEL can facilitate the writing of process fragments once and the later use of the written process fragments multiple times within the same process or across multiple processes.

The approach taken in the embodiment in FIG. 1 allows an employee performance management system to invoke a reconciliation process, or an automated process improvement. Typically employee performance management solutions gather data, perform some aggregations on the data, and present the results to end users. The end users in a contact center may typically include executives, regional managers, team managers, supervisors, and agents. A problem with the approach is that it is only a partial solution to the problem. Managers and supervisors are still required to take some action based upon the results that are presented, for example, in a classic balanced scorecard. This approach involves integration, aggregation, and analyzing, but is incomplete that it lacks additional required steps. Those steps are aided by the reconciliation and automated business process improvement features provided by the embodiment shown in FIG. 1.

One goal of contact centers employee performance management systems is to drive behavior based upon employee performance. This requires that an employee performance management solution consolidate acquired data within each application associated with the business goals. The performance manage reconciliation approaches described herein allow business users, executive, managers, and supervisors to associate particular reconciliation processes and business processes with particular performance management trends or triggers. This approach provides many benefits. For example, automation is possible. Best practice business processes may be automatically initiated via a given reconciliation process. A given reconciliation process 22 may manage each step of the business process, and take actions based upon timing, participations, results from previous steps, and interaction responses from optional external systems.

Another benefit is that business processes can be audited. A standard business process execution language may be utilized to produce business process definitions and logging procedures for logging information about individual business processes. When a business process is invoked, either based on trends or triggers in the performance data, this information including information about business process definitions will historically persist the outcome of each reconciliation process that has been invoked. This audit function gives the business owner and analyst a historical view into the resolutions caused by reconciliation processes, and a view into those situations where the reconciliation process does not result in a favorable resolution.

Another benefit is that a business process library can be created, including business processes 26 as shown in FIG. 1. These business processes can address what resolutions or improvements are desired for each use case, resulting in the creation of a best practices library, forming part of persisted data 27.

This allows advantages for vertical segment reuse. Business processes may be designated for use in, for example, telecom, finance, government, healthcare, and other vertical segments. Functional segment reuse may be facilitated, allowing business process to be used across different function segments, including, for example, sales, customer service, quality, training, and human resources. Another benefit is that the business processes may be open, so that each process for a specific vertical and function may be defined using a standard language (for example, a business process execution language), with an open extensible approach (e.g., using XML vocabulary) of defining the process for any compliant platform. This may allow the best practices library to be re-used in such platforms as Microsoft, IBM, Oracle, RedHat, and a custom-designed open BPEL (business process execution language) engine. In addition, versioning may be maintained so as to maintain an historical library of each best practice, who changed it, when it changed, why it changed, and to provide a label identification for all practices to group and certify specific versions of best practices for any given vertical or function area.

Another advantage of the approach described herein is the resulting efficiencies. By defining a best practice, and when a particular business process should be taken, and by associating these business processes to a particular performance management metric or trigger event, managers and supervisors can be more efficient, and can focus their efforts and time in other areas. Instead of managers and supervisors reading and reacting to a particular performance metric, they can monitor best practices which are automatically initiated as well as monitor the analytics around those processes. This refines the resolution of a particular performance management task rather than requiring that the manager or supervisor initiate a task and then monitor the task.

Another advantage of the approach described herein is that target and measurement periods can be better managed. To effectively apply performance management processes, targets or goal setting for objectives is required, and such targets and goals must be assigned to individuals, teams, regions, or functions. Typically these targets may be assigned and observed based on history and manually adjusted as the business goals change or as the experience level of the assigned resource changes. The reconciliation processes and business processes herein can cause these targets to automatically and dynamically be changed as the reconciliation process is invoked for any use case where performance indicators have determined the need.

For example, this can cause good performance results or improved ratings by an individual. This may occur if an individual achieves certain performance results or a certain rating for more than 3 months for a specific objective. This performance indicator may trigger a business process, for example, which includes:
(a) accessing in the over-achievement of an individual;
(b) determining a length of time that this individual has been at a certain experience level;
(c) automatically increasing the target over the achieved objective and/or increasing the experience level of the individual, which may result in a global increase for all targets;
(d) sending appropriate notifications to individuals, supervisors, and management that this change has happen;
(e) automatically creating three key measurement periods for the effected objectives to determine how (1) performance for this individual was prior to the change, (2) performance for this individual was shortly after the change, and (3) performance for this individual was at a time after a longer duration since the change; and
(f) providing a full audit of how many times a performance increase has been automated and triggered, for example, per individual, team, manager, site, function, and region.

In one use case, for example, an employee may have reached a performance objective threshold for a defined period of time. The business process or the action that would result from this and be caused by a reconciliation process could include identifying that this breach and duration has happened, and automatically scheduling training or a coaching session with the employee in question.

In another use case, for example, an employee may have been overachieving for a defined period of time. A business practice resulting from this and carried out by the reconciliation process may determine that the employee's experience level should be increased when a defined induction time has passed and performance has been met for a given period of time (for example, one month). An automated business process for this best practice may be initiated automatically, in the form of a reconciliation process, the appropriate managers and employee may be notified appropriately of the change.

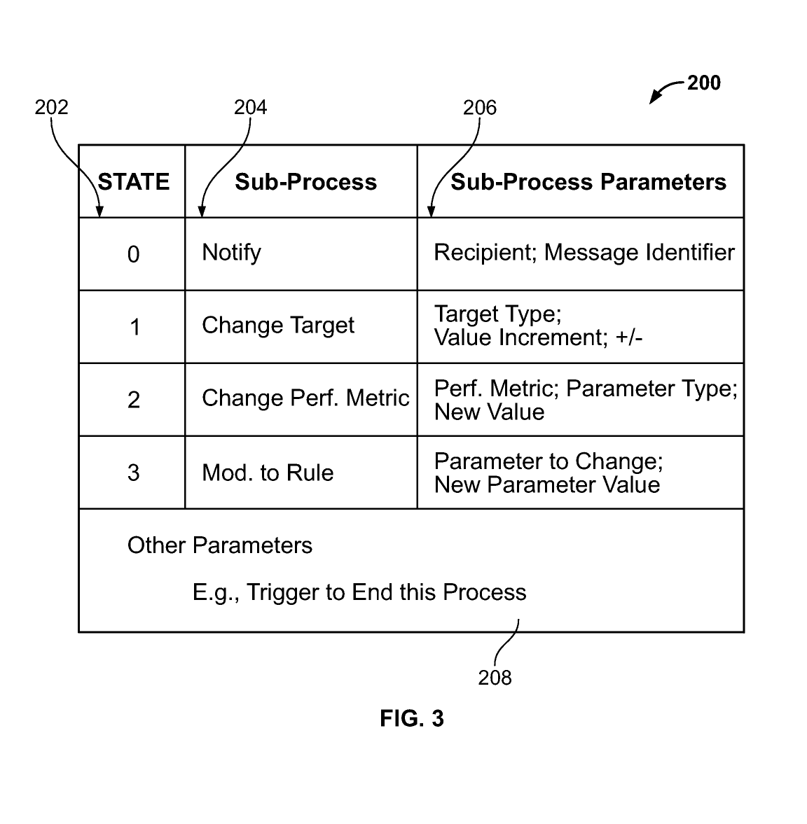

FIG. 3 illustrates media-stored reconciliation process fields, or an interface, for example, presented as part of a computer screen displayed user interface. The illustrated reconciliation process fields 200 include identifier fields 202 (in this example including the number 0, 1, 2, and 3) configured to hold reconciliation process state identifiers. The illustrated reconciliation process fields may further include a sub-process field 204, shown in a column in FIG. 3. The sub-process fields 204 are associated with respective state identifiers 202, and are configured to hold sub-process identifiers identifying sub-processors to be executed during execution of the reconciliation process. In this example, the sub-process identifiers include a “notify” sub-process, a “change target” sub-process, a “change performance metric” sub-process, and a “modification to rule” sub-process.

These identifiers may refer to API calls or process calls, or may include links to processes. Corresponding sub-process parameters 206 may be provided, which are shown in this example in another column, having a given sub-process parameter 206 corresponding to a given sub-process identifier 204 being in the same row. In the illustrated example, sub-process parameters corresponding to a “notify” sub-process include the recipient or recipients to be notified, and a message identifier identifying the message to be sent. In the event that the sub-process is a “change target” process, the corresponding sub-process parameters may include, for example, a target type, the value increment by which the target should be changed, and whether or not the increment should be added or subtracted. The sub-process parameters corresponding to a “change performance metric” sub-process may include, for example, the performance metric to be changed, the parameter type in that performance metric to be changed, and the new value for that parameter type. For a sub-process causing a “modification to a rule,” the corresponding sub-process parameters may include the parameter of the rule to be changed, and the new parameter value to which the parameter value in the rule should be changed to. The illustrated reconciliation process fields 200 may further include other parameters 208. For example, the other parameters may include information indicating when to trigger an end to the current reconciliation process.

In connection with the reconciliation process fields 200 as shown in FIG. 3, a reconciliation process association mechanism is provided which is configured to associate the given parameters, upon being held by the reconciliation process fields, with a media-stored corresponding reconciliation process defined at least in part by the given parameters. The reconciliation process includes instructions that, when executed, are configured to cause a change of one or more configuration parameters. In the example shown in FIG. 3, instructions are included which cause a change in performance metrics by a modification to a rule. Another change in a configuration parameter is caused by the “change target” sub-process.

In accordance with the sub-processes included in a given reconciliation process, a set of media-stored sub-processes is included which include configuration parameter change sub-processes, each of which, when executed, instructs a change of one or more configuration parameters of at least one performance factor system. The change may be an automated change. The at least one performance factor system may be a performance management system, and the one or more configuration parameters being changed may be changing a given metric target.

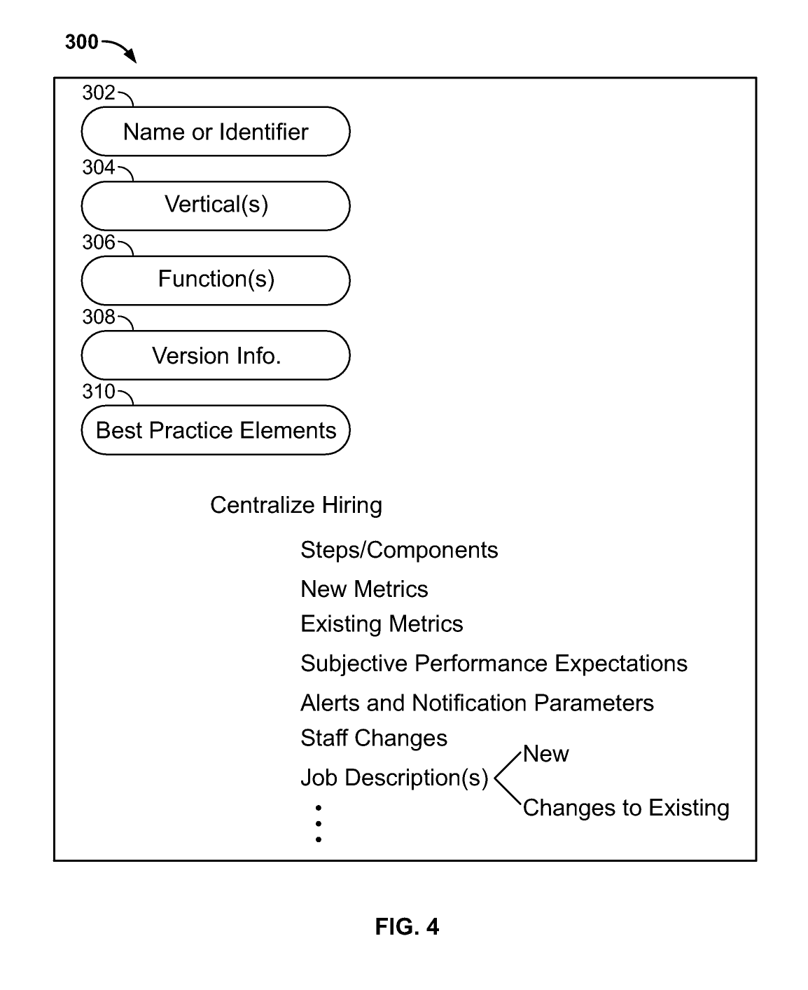

FIG. 4 is a schematic diagram of a business process definition data structure and/or user interface. The illustrated business process definition 300 includes a number of business process definition fields. In the illustrated embodiment, they are presented as part of a computer screen displayed user interface. They may be displayed simultaneously, or in parts, in different screen shots or windows, all on the screen at the same time, or on the screen at different times. The business process definition fields 300 include at least one identifier field 302 which is configured to hold an identifier parameter to identify the business process being defined. A vertical segment identifier field or fields 304 may be provided to hold a vertical segment identifier field (or a set of plural vertical segment identifier fields). Those vertical segment identifiers that may be chosen or indicated may include, for example, telecom, finance, government, healthcare, and so. A function field or fields 306 may be provided to hold one or more function identifiers. A version field or fields 308 may be provided to hold version information. One or more best practice elements 310 may be provided, which describe the best practice elements for the business process definition. In the illustrated example, those include (merely for illustration purposes) centralized hiring, steps/components of centralizing hiring, new metrics, existing metrics, subjective performance expectations, alerts and notification parameters, staff changes, job descriptions for new jobs and changes to existing jobs, and so on.

An association mechanism may be provided which is configured to associate given parameters indicated in the definition 300 as shown in FIG. 4, upon being held by the business process definition fields, with a media-stored corresponding business process defined at least in part by the given parameters. The business process definition may include an XML document, where the XML document includes the business process definition fields. The business process definition shown in FIG. 4 may include an XML document where the XML document is in the form of a media-stored corresponding business process.

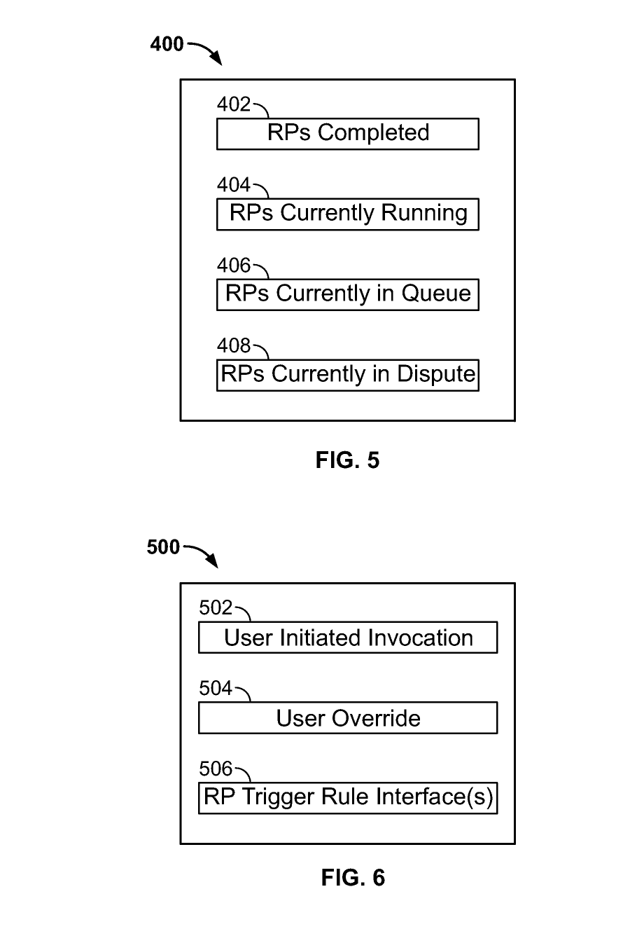

FIG. 5 is a schematic diagram of reconciliation process status console. The reconciliation process status console may include a number of reconciliation process status interface elements. Those elements may include reconciliation process status information interface tools 400, configured to present to a user, via one or more computer screen displayed graphical representations, data conveying reconciliation processes, certain status information regarding the reconciliation processes, and other information about the reconciliation processes. In the illustrated embodiment, the data conveying the reconciliation processes, the status information regarding the reconciliation processes and the other information about the reconciliation processes may each pertain to a particular class of reconciliation processes which may be accessed via a given graphical tool 402, 404, 406, and/or 408. For example, in the illustrated embodiment, those classes of reconciliation processes include reconciliation processes completed 402, reconciliation processes currently running 404, reconciliation processes currently in queue 406 and reconciliation processes currently in dispute 408.

FIG. 6 is a schematic diagram of a reconciliation process control interface 500. The illustrated interface 500 may include reconciliation process invocation control tools, which in the illustrated embodiment, include graphical tools 502, 504, and 506. Those tools are configured to present, to a user, via one or more computer screen graphical representations, controls to effect how and when an invocation-causing state change is made to occur by a reconciliation process invoker. The invocation causes the state change being intended to cause an invocation of a reconciliation process resulting in a change of one or more configuration parameters of at least one performance factor system. The performance factor system may be a performance management system, and the configuration parameters may include, for example, a given metric target.

In the illustrated embodiment shown in FIG. 6, the reconciliation process invocation control tools include a user initiated invocation control tool 502, a user override control tool 504, and a reconciliation process trigger rule interface or interfaces 506, for accessing and allowing a user to define different reconciliation process trigger rules. One simplified example of a reconciliation process trigger rule could be a reconciliation process trigger associated with a schedule adherence performance metrics. For example, if an objective for schedule adherence is reached by a certain level over a specific period of time (for example 80% over a period of a given month), a reconciliation process may be invoked pertaining to a schedule adherence. Such a reconciliation process may involve automatically alerting a number of personnel including the employees affected, their supervisors and managers, and changing the expected values. For example, the employees affected may be provided with a twenty minute break instead of a fifteen minute break. In addition, the threshold for the determination that a given person is at or below their schedule adherence expectations could be changed. The trigger rule itself could be changed.

For purposes of the present disclosure, a “field” is a place where information can be held, stored, or in the case of a user interface, input from a user and/or displayed back to the user via the computer screen. Such information can be typed into the field, selected by a drop down menu, selected from another file or link, for example, with the use of a URL information or a browse function. The computer interfaces illustrated in the figures herein include certain graphical tools, for example, icons or otherwise manipulable graphical tools. These tools may include displayed information as well as fields for inputting information into a computer system.

The processing performed by the elements shown in the figures herein may be performed by a general purpose computer, and/or or specialized processing computer. Such processing may performed by a single platform, by a distributed processing platform, or by separate platforms. In addition, such processing can be implemented in the form of special purpose hardware, or in the form of software being run by a general purpose computer. Any data handled in such processing or created as a result of such processing can be stored in any type of memory. For example, such data may be stored in a temporary memory, such as in the RAM of a given computer system or subsystem. In addition, or in the alternative, such data may be stored in longer-term storage devices, for example, magnetic discs, rewritable optical discs, and so. For purposes of the disclosure herein, machine-readable or computer-readable media may comprise any form of data storage mechanism, including such memory technologies as well as hardware or circuit representations of such structures and of such data. The processes may be implemented in any machine-readable media and/or or in an integrated circuit.

The claims as originally presented and as they may be amended, encompass variations, alternatives, modifications, improvements, equivalents and substantial equivalents of the embodiments and teachings disclosed herein, including those that are presently unforeseen or unappreciated, and that, for example, may arise from applicants/patentees and others.

What is claimed is:

1. Apparatus comprising:
a reconciliation process invoker configured to cause a given state change intended to invoke a given reconciliation process;
media-stored reconciliation processes, including the given reconciliation process, executable by a reconciliation process execution mechanism; and
wherein the media-stored given reconciliation process includes instructions configured to instruct a change, upon execution of the given reconciliation process execution mechanism, of one or more configuration parameters of at least one performance factor system.

2. The apparatus according to claim 1, further comprising a reconciliation process execution mechanism configured to execute, when installed and executed by a general purpose processor, the given reconciliation process when the given state change has been caused by the reconciliation process invoker.

3. The apparatus according to claim 1, wherein the one or more configuration parameters includes a given metric target.

4. The apparatus according to claim 1, wherein the instructed change of the one or more configuration parameters includes an automated change of the one or more configuration parameters.

5. The apparatus according to claim 1, wherein the reconciliation process invoker includes a plural set of reconciliation process trigger rules, wherein each of the reconciliation process trigger rules is configured to cause invoking of an associated one of the reconciliation processes, a given one of the reconciliation process trigger rules being configured to cause invoking of the given reconciliation process.

6. Apparatus comprising:
reconciliation process fields, the reconciliation process fields including, in part, state identifying fields configured to hold reconciliation process state identifiers, sub-process fields, associated with respective states identified by ones of the process state identifiers, configured to hold sub-process identifiers identifying sub-processes to be executed during execution of the reconciliation process, and to hold corresponding sub-process parameters for the identified sub-processes;
a reconciliation process association mechanism configured to associate given parameters, upon being held by the reconciliation process fields, with a media-stored corresponding reconciliation process defined at least in part by the given parameters, and the reconciliation process including an instruction that, when executed, is configured to cause a change of one or more configuration parameters; and
a set of media-stored sub-processes including configuration parameter change sub-processes each of which, when executed, instructs a change of one or more configuration parameters of at least one performance factor system.

7. The apparatus according to claim 6, wherein the reconciliation process fields are presented as a part of a computer screen displayed user interface.

8. The apparatus according to claim 6, wherein the instruction of a change of one or more configuration parameters includes an automated change of the one of more configuration parameters.

9. The apparatus according claim 6, wherein the at least one performance factor system includes a performance management system.

10. The apparatus according to claim 6, wherein the one or more configuration parameters include a given metric target.

11. Apparatus comprising:
business process definition fields, the business process definition fields including at least one identifier field configured to hold an identifier parameter to identify the business process being defined, a vertical segment field to hold a vertical segment identifier field, a function field to hold a function identifier, and a version field to hold version data; and
an association mechanism configured to associate given parameters, upon being held by the business process definition fields, with media-stored corresponding business processes defined at least in part by the given parameters.

12. The apparatus according to claim 11, wherein the business process definition fields are represented as a computer screen display user interface.

13. The apparatus according to claim 11, further comprising an XML document, the XML document including the business process definition fields.

14. The apparatus according to claim 11, further comprising an XML document, the XML document being the media-stored corresponding business process.

15. Apparatus including a reconciliation process status interface, the reconciliation process status interface comprising:
reconciliation process status information interface tools configured to present, to a user, via one or more computer screen displayed graphical representations, data conveying reconciliation processes, certain status information regarding the reconciliation processes, and other information about the reconciliation processes.

16. The apparatus according to claim 15, wherein the interface tools include a category identifier of reconciliation processes completed.

17. The apparatus according to claim 15, wherein the interface tools include a graphical identifier identifying a category of reconciliation processes including reconciliation processes currently running.

18. The apparatus according to claim 15, wherein the interface tools are configured to present a category of reconciliation processes including reconciliation processes currently in queue.

19. The apparatus according to claim 15, wherein the interface tools include a graphical indicator indicating a category of reconciliation processes including reconciliation processes currently in dispute.

20. Apparatus including a reconciliation process invocation control interface, the reconciliation process invocation control interface comprising:
reconciliation process invocation control tools, configured to present to a user, via one or more computer screens graphical representations, controls to affect how and when an invocation-causing state change is made to occur by reconciliation process invoker, the invocation-causing state change being intended to cause an invocation of a reconciliation process resulting in a change of one or more configuration parameters of at least one performance factor system.

21. The apparatus according to claim 20, wherein at least one performance factor system includes a performance management system.

22. The apparatus according to claim 20, wherein the one or more configuration parameters include a given metric target.
